(19) United States
(12) Patent Application Publication
(10) Pub. No.: US 2014/0059858 A1
(43) Pub. Date: Mar. 6, 2014

(54) Heat-Dissipating Device and Method for Manufacturing the Same

(71) Applicant: Asia Vital Components Co., Ltd., New Taipei City (TW)

(72) Inventors: Kuo-Sheng Lin, New Taipei City (TW); Li-Min Sun, New Taipei City (TW); Ching-Hsiang Cheng, New Taipei City (TW)

(73) Assignee: Asia Vital Components Co., Ltd., New Taipei City (TW)

(21) Appl. No.: 14/072,134

(22) Filed: Nov. 5, 2013

Related U.S. Application Data
(62) Division of application No. 12/917,432, filed on Nov. 1, 2010.

(30) Foreign Application Priority Data
May 14, 2010 (TW) 099115434

(51) Int. Cl. B23P 15/26

(52) U.S. Cl. CPC B23P 15/26
USPC 29/890.046

(57) ABSTRACT

The present invention provides a heat-dissipating device and a method for manufacturing the same. The heat-dissipating device includes a heat sink and a heat pipe. The heat sink has an end surface provided with a groove. The heat pipe is received in the groove. The heat pipe has a heat-absorbing surface and a heat-conducting surface. The heat-conducting surface is adhered to the inner edge of the groove. The heat-absorbing surface is in flush with the end surface. With this arrangement, heat resistance of the heat-dissipating device is reduced to improve the heat-dissipating effect thereof.

This application claims the priority benefit of Taiwan patent application number 099115434 filed on May 14, 2010.

### BACKGROUND OF THE INVENTION

1. Field of the Invention

The present invention relates to a heat-dissipating device and a method for manufacturing the same, and in particular to a heat-dissipating device and a method for manufacturing the same, whereby manufacturing cost is saved and heat resistance is reduced.

2. Description of Prior Art

Currently, heat pipe is a heat-conducting element widely used in electronic apparatuses and electronic elements. In general, the interior of the heat pipe is filled with a heat-conducting medium of good flowability, high heat of vaporization, low boiling point and stable chemical properties, such as water, ethanol, acetone or the like. The inner surfaces of the heat pipe are usually formed with a wick structure having a lot of protrusions.

In operation, one of the heat pipe acts as an evaporating section connected to a base of an electronic element, and the other end of the heat pipe acts as a condensing section assembled with a plurality of heat-dissipating fins. With this arrangement, when the evaporating section of the heat pipe is heated, the heat-conducting medium located in the evaporating section is vaporized to absorb a lot of latent heat of evaporation. As a result, the temperature of the base can be lowered. Then, the vapor-phase heat-conducting medium diffuses to the condensing section. The vapor-phase heat-conducting medium condenses into its liquid phase to release a lot of latent heat of condensation and flows back to the evaporating section through the wick structure. The heat-dissipating fins assembled with the condensing section dissipate the latent heat of condensation to the outside.

Please refer to FIG. 1, which is an exploded perspective view showing a conventional heat-dissipating device. The heat-dissipating device 3 is constituted of a heat sink 31 having fins, a base 32 and at least one heat pipe 33. The heat sink 31 has a heat-absorbing portion 311 and a heat-dissipating portion 312. The heat-absorbing portion 311 is adhered to the base 32. One end of the heat pipe 33 is disposed between the heat-absorbing portion 311 and the base 32. The other end of the heat pipe 33 is disposed through the heat-dissipating portion 312. The heat-dissipating device 3 is brought into thermal contact with the base 32 to absorb the heat generated by a heat source 4. The heat is conducted from the base 32 to the heat sink 31 and the heat pipe 33, and then the heat is conducted from the heat pipe 33 to the heat-dissipating portion 312 of the heat sink 31. By this structure, the heat-dissipating efficiency of the whole heat-dissipating device can be improved.

The base 32 of the conventional heat-dissipating device 3 has the following functions. The base 32 is combined with the heat sink 31 to directly conduct the heat to the heat-dissipating portion 312 of the heat sink 31. Further, one side of the base 32 is provided with at least one groove 321 for allowing the heat pipe 33 to be received in and combined with the heat sink 31 because the heat pipe 33 is formed into a cylindrical pipe and unable to contact the heat source 4 properly. With the base 32 being brought into thermal contact with the heat source 4 to absorb the heat generated by the heat source 4, the heat can be conduct from the base 32 to the heat sink 31 and the heat pipe 33.

Since a gap is inevitably formed between two connected heat-dissipating elements, heat resistance is generated between these two heat-dissipating elements. In order to reduce the heat resistance, these two heat-dissipating elements can be soldered together by electrical-conductive solder. However, when a plurality of heat-dissipating elements is assembled together, the heat-dissipating efficiency of the whole structure is insufficient. On the other hand, it takes more time to assemble the plurality of heat-dissipating elements together, which undesirably raises the manufacturing cost.

Further, the combination of the base and the heat sink makes the whole heat-dissipating device bulky and unable to be moved easily. Also, such a large-sized heat-dissipating device occupies more space, so that the application thereof is limited.

According to the above, the conventional heat-dissipating device has drawbacks as follows: (1) higher cost; (2) more working hours for assembly; (3) unable to be used in a smaller space; and (4) low in heat-conducting and heat-dissipating efficiency.

### SUMMARY OF THE INVENTION

A primary objective of the present invention is to provide a heat-dissipating device and a method for manufacturing the same, whereby the heat resistance thereof is reduced.

Another objective of the present invention is to provide a heat-dissipating device and a method for manufacturing the same, whereby the manufacturing cost thereof is reduced.

A further objective of the present invention is to provide a heat-dissipating device and a method for manufacturing the same, which can be assembled easily.

In order to achieve the above objectives, the present invention is to provide a heat-dissipating device including a heat sink and at least one heat pipe. The heat sink has a heat-dissipating portion and a heat-absorbing portion. The heat-absorbing portion has an end surface. The end surface is provided with at least one groove. The groove has an opening and a closed side. The heat pipe has a heat-absorbing end and a heat-dissipating end. The heat-absorbing end has a heat-absorbing surface and a heat-conducting surface. The heat-absorbing surface is adjacent to the heat-conducting surface. The heat-absorbing end of the heat pipe is inserted into the groove. The heat-dissipating end is disposed through the heat-dissipating portion. The heat-conducting surface is adhered to the closed side. The heat-absorbing surface is in flush with the end surface. The heat-dissipating end of the heat pipe is provided in the heat-dissipating portion of the heat sink. The heat-absorbing end of the heat pipe conducts the heat to the heat-dissipating end. Then, the heat-dissipating end conducts the heat to the heat-dissipating portion for heat dissipation.

The present invention further provides a method for manufacturing a heat-dissipating device. By this method, a planar surface is formed on at least one side of a heat pipe. At least one groove is formed on one side of heat-dissipating fins. The heat-dissipating fins are superposed together to form a heat sink. The heat pipe is disposed into the groove of the heat sink to form a heat-dissipating device or the heat pipe is disposed through the respective heat-dissipating fins to form a heat-dissipating device. In this way, the heat resistance and cost of the whole heat-dissipating device are reduced and an excellent heat-dissipating effect is achieved.

According to the above, the present invention has advantages as follows: (1) reduced manufacturing cost; (2) smaller heat resistance; and (3) less working hours and rapid assembly.

### BRIEF DESCRIPTION OF THE DRAWINGS

FIG. 1 is an exploded perspective view showing a conventional heat-dissipating device;

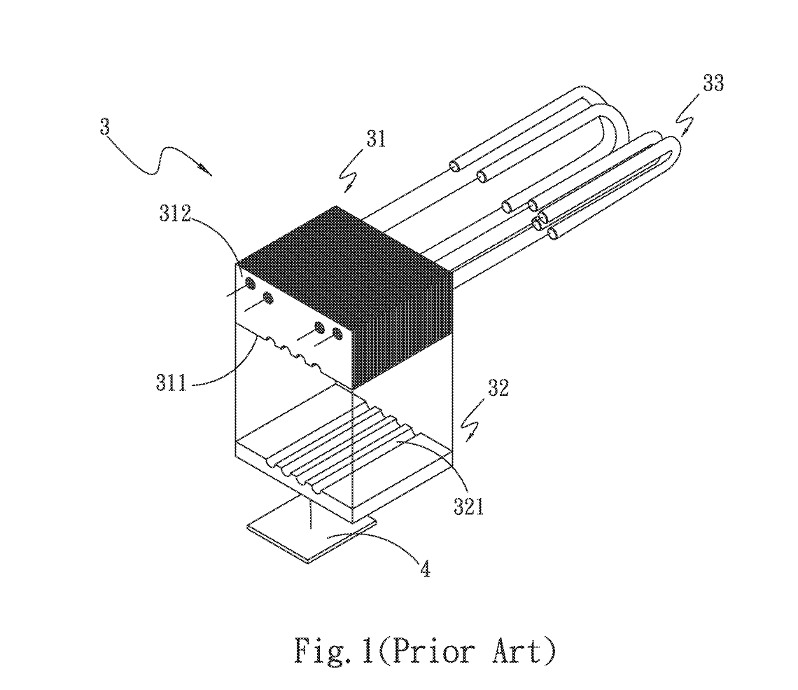

FIG. 2 is an exploded perspective view showing a heat-dissipating device according to a first embodiment of the present invention;

FIG. 3 is an assembled perspective view showing the heat-dissipating device according to the first embodiment of the present invention;

FIG. 4 is a front view showing the heat-dissipating device according to the first embodiment of the present invention;

FIG. 5 is an assembled perspective view showing the heat-dissipating device according to a second embodiment of the present invention;

FIG. 6 is a flow chart showing a method for manufacturing the heat-dissipating device according to a first embodiment of the present invention;

FIG. 7 is a flow chart showing a method for manufacturing the heat-dissipating device according to a second embodiment of the present invention;

FIG. 8 is a flow chart showing a method for manufacturing the heat-dissipating device according to a third embodiment of the present invention; and

FIG. 9 is a flow chart showing a method for manufacturing the heat-dissipating device according to a fourth embodiment of the present invention.

### DETAILED DESCRIPTION OF THE INVENTION

The above objectives and structural and functional features of the present invention will be described in more detail with reference to preferred embodiment thereof shown in the accompanying drawings

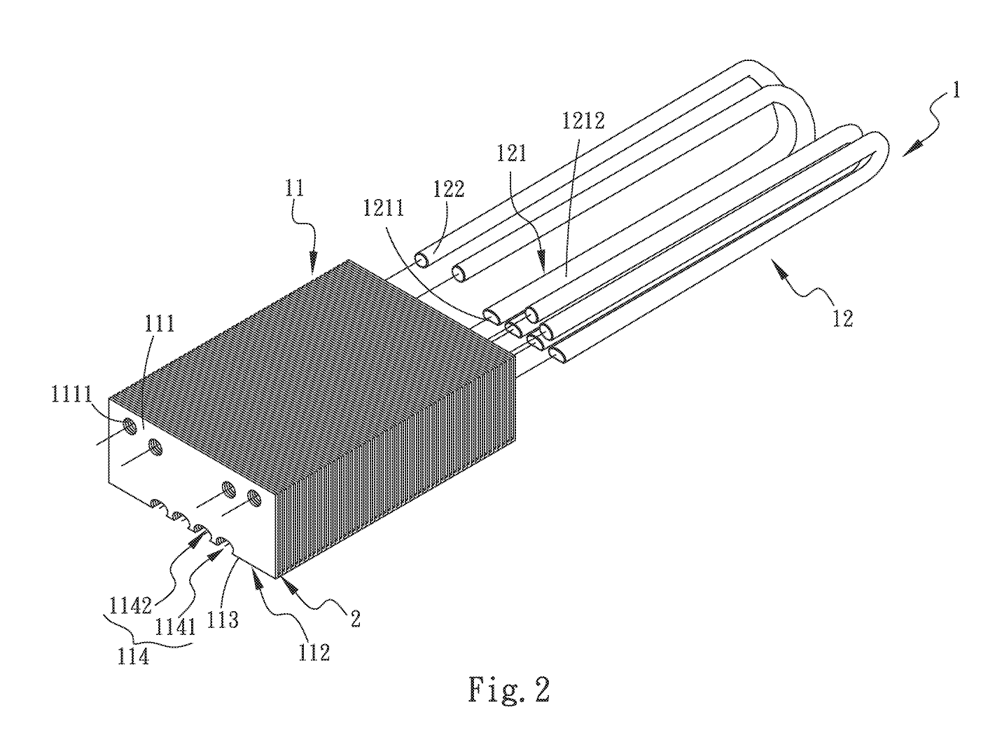

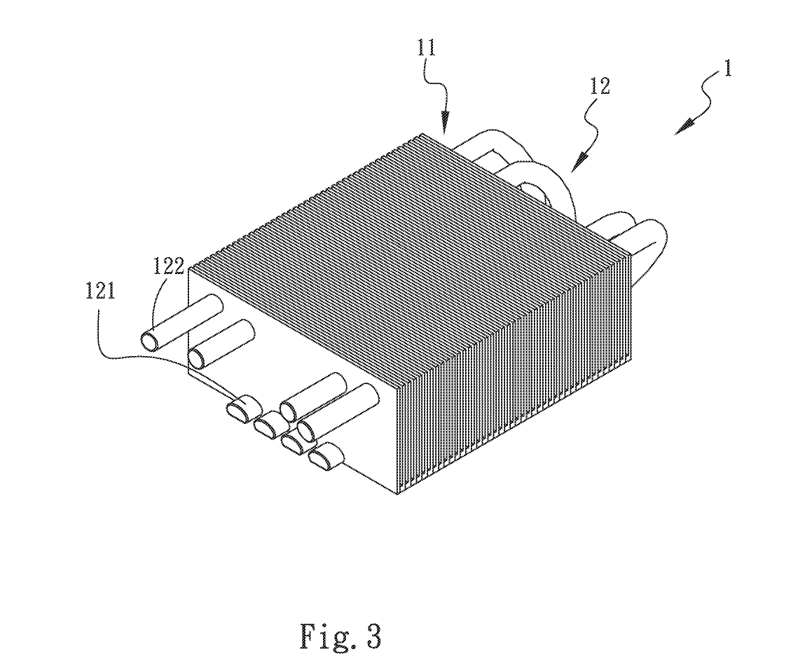

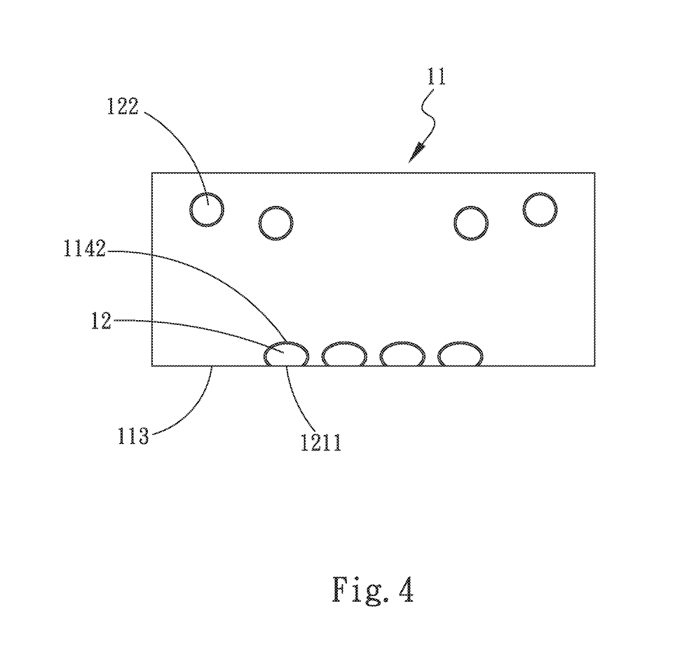

FIG. 2 is an exploded perspective view showing a heat-dissipating device according to a first embodiment of the present invention, FIG. 3 is an assembled perspective view showing the heat-dissipating device according to the first embodiment of the present invention, and FIG. 4 is a front view showing the heat-dissipating device according to the first embodiment of the present invention. As shown in these figures, the heat-dissipating device 1 includes a heat sink 11 and at least one heat pipe 12.

The heat sink 11 is constituted by superposing a plurality of heat-dissipating fins 2. The heat sink 11 has a heat-dissipating portion 111 and a heat-absorbing portion 112. The heat-absorbing portion 111 has an end surface 113. The end surface 113 is provided with at least one groove 114. The groove 114 has an opening 1141 and a closed side 1142. The heat-dissipating portion 111 is connected to the heat-absorbing portion 112. The heat-dissipating portion 111 is formed by extending from one side of the heat-absorbing portion 112 away from the heat-absorbing portion 112. The heat-dissipating portion 111 is provided with at least one hole 1111.

The heat pipe 12 has a heat-absorbing end 121 and a heat-dissipating end 122. The heat-absorbing end 121 has a heat-absorbing surface 1211 and a heat-conducting surface 1212. The heat-absorbing surface 1211 is adjacent to the heat-conducting surface 1212. The heat-absorbing end 121 of the heat pipe 12 is inserted into the groove 114. The heat-dissipating end 122 is disposed through the heat-dissipating portion 111 in such a manner that the heat-conducting surface 1212 is adhered to the closed side 1142 and the heat-absorbing surface 1211 is in flush with the end surface 113.

The diameter of the opening 1141 of the heat sink 11 is smaller than the diameter of the closed side 1142. The shape of the groove 114 is the same as the cross-sectional shape of the heat-absorbing end 121.

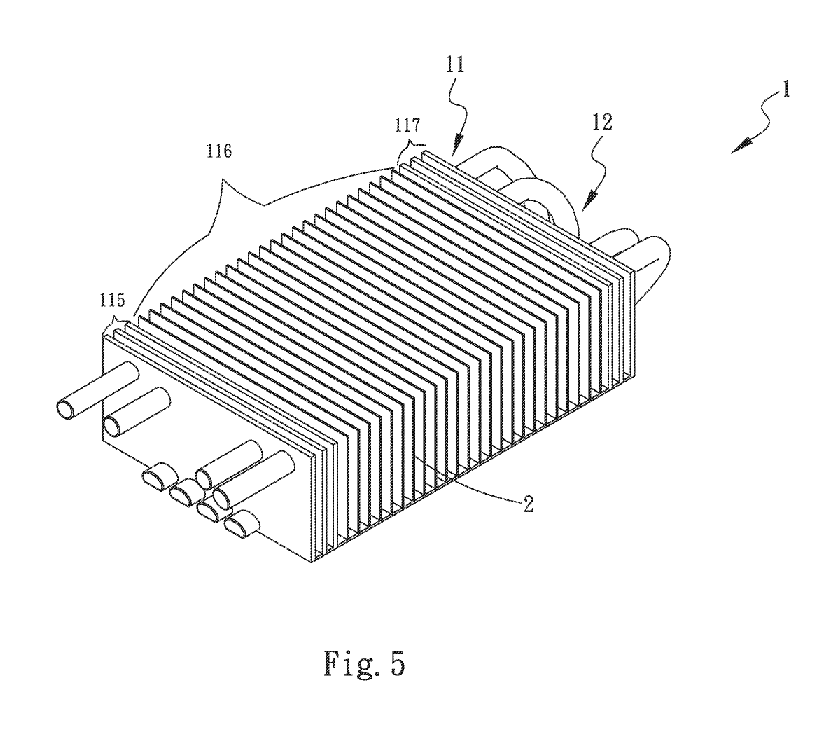

FIG. 5 is an assembled perspective view showing the heat-dissipating device according to a second embodiment of the present invention. As shown in this figure, the heart sink 11 further includes a first portion 115, a second portion 116 and a third portion 117. The first portion 115 and the third portion 117 are provided on both ends of the second portion 116. The thickness of the heat-dissipating fin 2 located in the first portion 115 and the third portion 117 is larger than that of the heat-dissipating fin 2 located in the second portion 116. Alternatively, the heat-dissipating fin may be made of a material of a larger structural strength to thereby increase the strength of the whole heat-dissipating device 1.

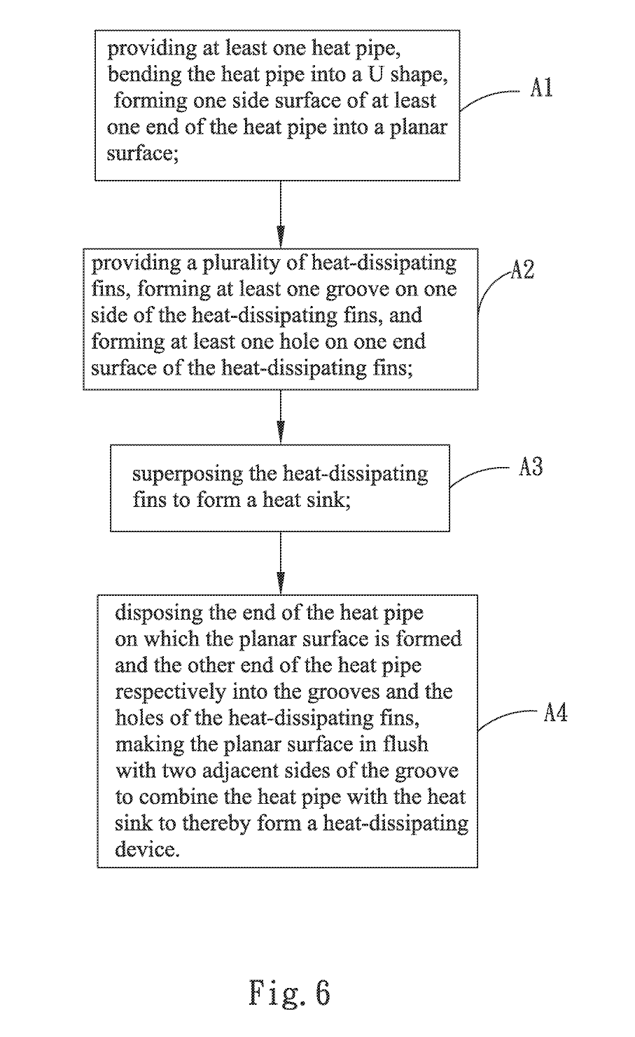

FIG. 6 is a flow chart showing a method for manufacturing the heat-dissipating device according to a first embodiment of the present invention. Please also refer to FIGS. 2 to 4. As shown in these figures, the method for manufacturing a heat-dissipating device according to the present invention includes steps as follows.

A1: providing at least one heat pipe, bending the heat pipe into a U shape, forming one side surface of at least one end of the heat pipe into a planar surface.

In the step A1, at least one heat pipe 12 is provided. The heat pipe 12 is bent into a U shape. One side surface of at least one end (such as the heat-absorbing end 121) of the heat pipe 12 is formed into a planar surface (such as the heat-absorbing surface 1211) by means of a machining process such as pressing or milling.

A2: providing a plurality of heat-dissipating fins, forming at least one groove on one side of the heat-dissipating fins, and forming at least one hole on one end surface of the heat-dissipating fins.

In the step A2, a plurality of heat-dissipating fins 2 is provided. On side (such as the end surface 113) of the heat-dissipating fins 2 is formed with at least one groove 114. One end surface (such as the heat-dissipating portion 111) of the heat-dissipating fins 2 is formed with at least one hole 1111.

A3: superposing the heat-dissipating fins to form a heat sink;

In the step A3, the heat-dissipating fins 2 formed with the grooves 114 and the holes 1111 are superposed together to form a heat sink 11.

A4: disposing the end of the heat pipe on which the planar surface is formed and the other end of the heat pipe respectively into the grooves and the holes of the heat-dissipating fins respectively, making the planar surface in flush with two adjacent sides of the groove to combine the heat pipe with the heat sink to thereby form a heat-dissipating device.

In the step A4, one end (the heat-absorbing end 121) of the heat pipe 12 on which the planar surface is formed and the other end (heat-dissipating end 122) of the heat pipe 12 are disposed respectively into the grooves 113 and the holes 1111 of the heat-dissipating fins 2. The planar surface (the heat-absorbing surface 1211) is made in flush with the adjacent sides of the groove 114 (i.e. the end surface 113) to combine the heat pipe 12 with the heat sink 11 to thereby form a heat-dissipating device 1.

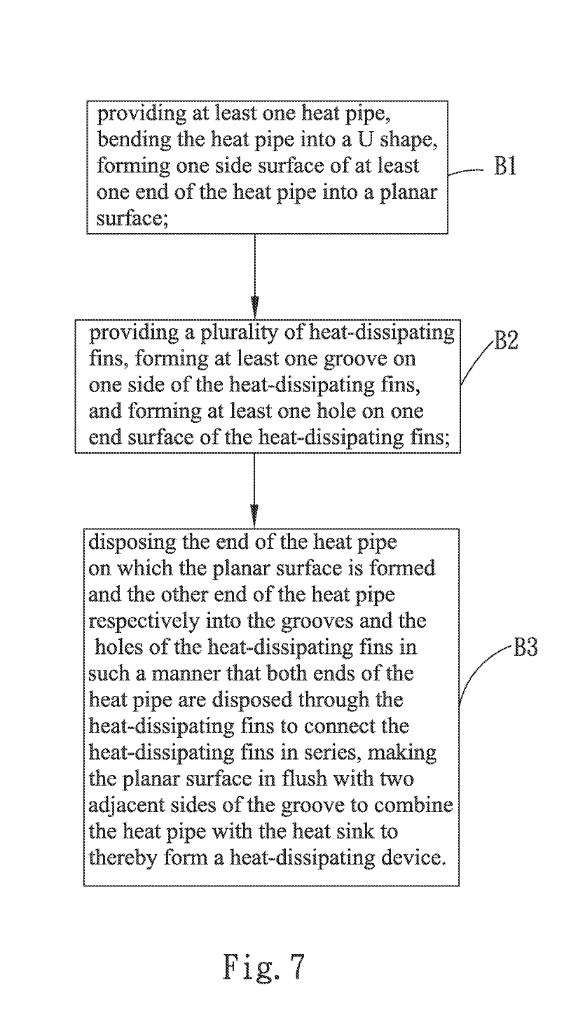

FIG. 7 is a flow chart showing a method for manufacturing the heat-dissipating device according to a second embodiment of the present invention. Please also refer to FIGS. 2 to 4. As shown in these figures, the method for manufacturing a heat-dissipating device according to the present invention includes steps as follows.

B1: providing at least one heat pipe, bending the heat pipe into a U shape, forming one side surface of at least one end of the heat pipe into a planar surface.

In the step B1, at least one heat pipe 12 is provided. The heat pipe 12 is bent into a U shape. One side surface of at least one end (e.g., the heat-absorbing end 121) of the heat pipe 12 is formed into a planar surface (e.g., the heat-absorbing surface 1211) by means of a machining process such as pressing or milling.

B2: providing a plurality of heat-dissipating fins, forming at least one groove on one side of the heat-dissipating fins, and forming at least one hole on one end surface of the heat-dissipating fins.

In the step B2, a plurality of heat-dissipating fins 2 is provided. On side (such as the end surface 113) of the heat-dissipating fins 2 is formed with at least one groove 114. One end surface (e.g., the heat-dissipating portion 111) of the heat-dissipating fins 2 is formed with at least one hole 1111.

B3: disposing the end of the heat pipe on which the planar surface is formed and the other end of the heat pipe into the grooves and the holes of the heat-dissipating fins in such a manner that both ends of the heat pipe are disposed through the heat-dissipating fins to connect the heat-dissipating fins in series, making the planar surface in flush with two adjacent sides of the groove to combine the heat pipe with the heat sink to thereby form a heat-dissipating device.

In the step B3, one end (the heat-absorbing end 121) of the heat pipe 12 on which the planar surface is formed and the other end (the heat-dissipating end 122) of the heat pipe 12 are disposed respectively into the grooves 113 and the holes 1111 of the heat-dissipating fins 2 in such a manner that both ends (the heat-absorbing end 121 and the heat-dissipating end 122) of the heat pipe 12 are disposed through the heat-dissipating fins 2 to connect the heat-dissipating fins 2 in series. The planar surface (the heat-absorbing surface 1211) is made in flush with the adjacent sides of the groove 114 (i.e. the end surface 113) to combine the heat pipe 12 with the heat sink 11 to thereby form a heat-dissipating device 1.

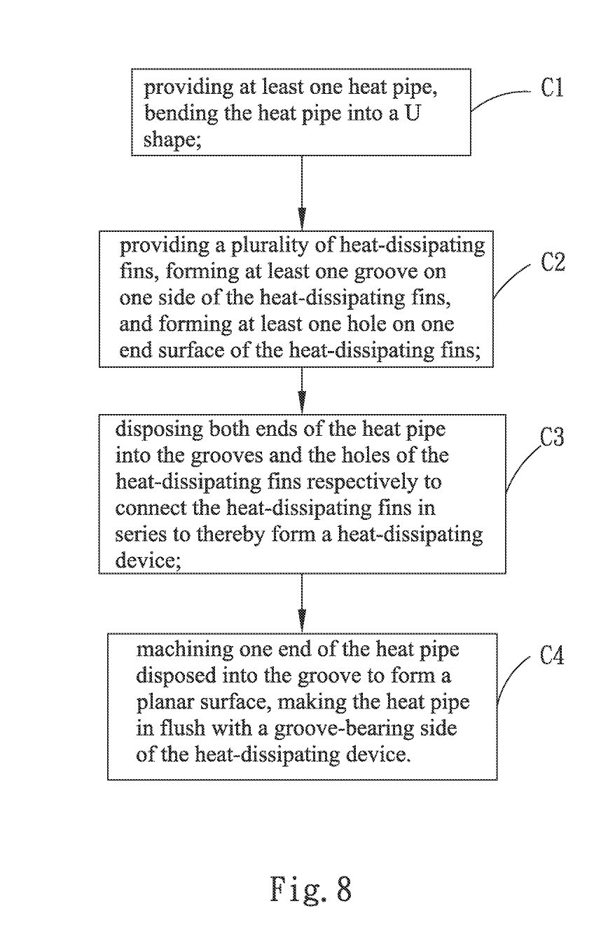

FIG. 8 is a flow chart showing a method for manufacturing the heat-dissipating device according to a third embodiment of the present invention. Please also refer to FIGS. 2 to 4. As shown in these figures, the method for manufacturing a heat-dissipating device according to the present invention includes steps as follows.

C1: providing at least one heat pipe, bending the heat pipe into a U shape.

In the step C1, at least one heat pipe 12 is provided. The heat pipe 12 is bent into a shape.

C2: providing a plurality of heat-dissipating fins, forming at least one groove on one side of the heat-dissipating fins, and forming at least one hole on one end surface of the heat-dissipating fins.

In the step C2, a plurality of heat-dissipating fins 2 is provided. On side (e.g., the end surface 113) of the heat-dissipating fins 2 is formed with at least one groove 114. One end surface (e.g., the heat-dissipating portion 111) of the heat-dissipating fins 2 is formed with at least one hole 1111.

C3: disposing both ends of the heat pipe respectively into the grooves and the holes of the heat-dissipating fins to connect the heat-dissipating fins in series to thereby form a heat-dissipating device;

In the step C3, both ends (the heat-absorbing end 121 and the heat-dissipating end 122) of the heat pipe 12 are respectively disposed into the grooves 114 and the holes 1111 of the heat-dissipating fins 2 to connect the heat-dissipating fins 2 in series to thereby form a heat-dissipating device 1.

C4: machining one end of the heat pipe disposed into the groove to form a planar surface, making the heat pipe to be in flush with one groove-bearing side of the heat-dissipating device.

In the step C4, one end (the heat-absorbing end 121) of the heat pipe 12 disposed into the groove 114 is machined by pressing or milling to form a planar surface (the heat-absorbing surface 1211). The planar surface (the heat-absorbing surface 1211) of the heat pipe 12 is made to be in flush with one side (the end surface 113) of the heat-dissipating device 1 having the groove 114.

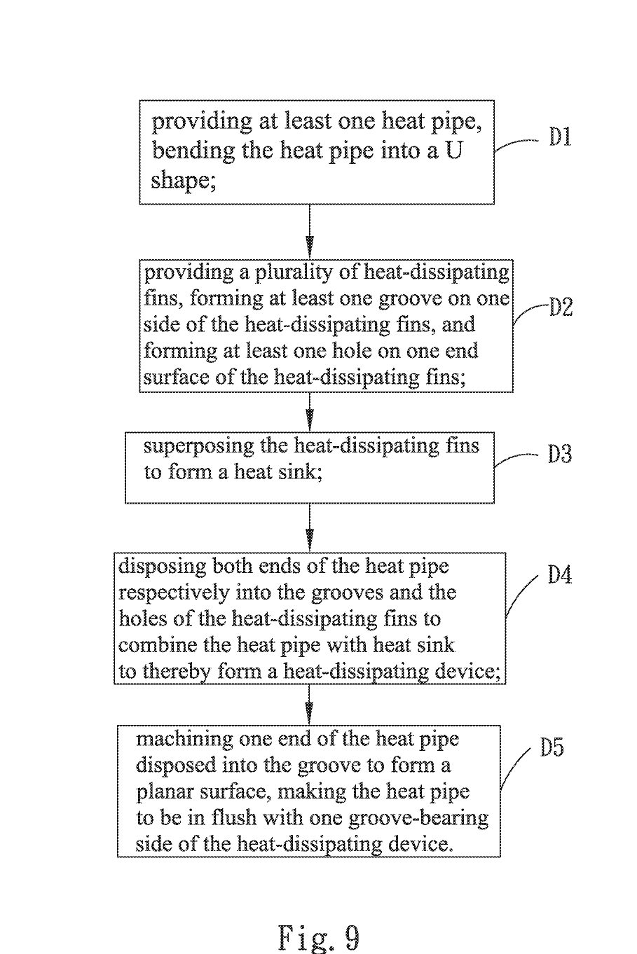

FIG. 9 is a flow chart showing a method for manufacturing the heat-dissipating device according to a fourth embodiment of the present invention. Please also refer to FIGS. 2 to 4. As shown in these figures, the method for manufacturing a heat-dissipating device according to the present invention includes steps as follows.

D1: providing at least one heat pipe, bending the heat pipe into a U shape.

In the step D1, at least one heat pipe 12 is provided. The heat pipe 12 is bent into a U shape.

D2: providing a plurality of heat-dissipating fins, forming at least one groove on one side of the heat-dissipating fins, and forming at least one hole on one end surface of the heat-dissipating fins.

In the step D2, a plurality of heat-dissipating fins 2 is provided. On side (e.g., the end surface 113) of the heat-dissipating fins 2 is formed with at least one groove 114. One end surface (e.g., the heat-dissipating portion 111) of the heat-dissipating fins 2 is formed with at least one hole 1111.

D3: superposing the heat-dissipating fins to form a heat sink;

In the step D3, the heat-dissipating fins 2 formed with the grooves 114 and the holes 1111 are superposed to form a heat sink 11.

D4: disposing both ends of the heat pipe respectively into the grooves and the holes of the heat-dissipating fins to thereby combine the heat pipe with heat sink to form a heat-dissipating device.

In the step D4, both ends (the heat-absorbing end 121 and the heat-dissipating end 122) of the heat pipe 12 are disposed into the grooves 114 and the holes 1111 of the heat-dissipating fins 2 to thereby combine the heat pipe 12 with heat sink 11 to form a heat-dissipating device 1.

D5: machining one end of the heat pipe disposed into the groove to form a planar surface, making the heat pipe to be in flush with one groove-bearing side of the heat-dissipating device.

In the step D5, one end (the heat-absorbing end 121) of the heat pipe 12 disposed into the groove 114 is machined by pressing or milling to form a planar surface (the heat-absorbing surface 1211). The planar surface (the heat-absorbing surface 1211) of the heat pipe 12 is made to be in flush with the groove-bearing side (the end surface 113) of the heat-dissipating device 1.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

1-4. (canceled)

5. A method for manufacturing a heat-dissipating device, including steps of:
providing at least one heat pipe, bending the heat pipe into a U shape, forming one side surface of at least one end of the heat pipe into a planar surface;
providing a plurality of heat-dissipating fins, forming at least one groove on one side of the heat-dissipating fins, and forming at least one hole on one end surface of the heat-dissipating fins;
superposing the heat-dissipating fins to form a heat sink; and
disposing the end of the heat pipe on which the planar surface is formed and the other end of the heat pipe respectively into the grooves and the holes of the heat-dissipating fins, making the planar surface in flush with two adjacent sides of the groove to combine the heat pipe with the heat sink to thereby form a heat-dissipating device.

6. A method for manufacturing a heat-dissipating device, including steps of:
providing at least one heat pipe, bending the heat pipe into a U shape, forming one side surface of at least one end of the heat pipe into a planar surface;
providing a plurality of heat-dissipating fins, forming at least one groove on one side of the heat-dissipating fins, and forming at least one hole on one end surface of the heat-dissipating fins;
disposing the end of the heat pipe on which the planar surface is formed and the other end of the heat pipe respectively into the grooves and the holes of the heat-dissipating fins in such a manner that both ends of the heat pipe are disposed through the heat-dissipating fins to connect the heat-dissipating fins in series, making the planar surface in flush with two adjacent sides of the groove to combine the heat pipe with the heat sink to thereby form a heat-dissipating device.

7. A method for manufacturing a heat-dissipating device, including steps of:
providing at least one heat pipe, bending the heat pipe into a U shape;
providing a plurality of heat-dissipating fins, forming at least one groove on one side of the heat-dissipating fins, and forming at least one hole on one end surface of the heat-dissipating fins;
disposing both ends of the heat pipe into the grooves and the holes of the heat-dissipating fins respectively to connect the heat-dissipating fins in series to thereby form a heat-dissipating device; and
machining one end of the heat pipe disposed into the groove to form a planar surface, making the heat pipe in flush with a groove-bearing side of the heat-dissipating device.

8. A method for manufacturing a heat-dissipating device, including steps of:
providing at least one heat pipe, bending the heat pipe into a U shape;
providing a plurality of heat-dissipating fins, forming at least one groove on one side of the heat-dissipating fins, and forming at least one hole on one end surface of the heat-dissipating fins;
superposing the heat-dissipating fins to form a heat sink;
disposing both ends of the heat pipe respectively into the grooves and the holes of the heat-dissipating fins to combine the heat pipe with heat sink to thereby form a heat-dissipating device; and
machining one end of the heat pipe disposed into the groove to form a planar surface, making the heat pipe to be in flush with one groove-bearing side of the heat-dissipating device.
